(19) United States
(12) Patent Application Publication
(10) Pub. No.: US 2026/0052307 A1
(43) Pub. Date: Feb. 19, 2026

(54) AUTOFOCUS CONVERGENCE PROCESSES WITHIN IMAGING DEVICES

(71) Applicant: QUALCOMM Incorporated, San Diego, CA (US)

(72) Inventors: Jintao XU, Beijing (CN); Yaoyao HOU, Beijing (CN); Mingchen GAO, Beijing (CN); Shenghua LIU, Beijing (CN); Xiaocheng WANG, Beijing (CN)

(21) Appl. No.: 19/103,509

(22) PCT Filed: Oct. 31, 2022
(86) PCT No.: PCT/CN2022/128590

§ 371 Date: Feb. 12, 2025

(51) Int. Cl. H04N 23/67; H04N 23/68

(52) U.S. Cl. CPC H04N 23/675; H04N 23/671; H04N 23/673; H04N 23/6811

(57) ABSTRACT

Methods, systems, and apparatuses are provided to enhance autofocus processes based on the detected motion of objects within captured images and rotational movements of an imaging device. For example, an imaging device may receive a lens defocus value and a lens position for a lens based on applying an autofocus process to an image. The imaging device may also receive a motion value characterizing a motion of an object within the image, and a rotation value characterizing a rotation of the imaging device. Further, the imaging device may determine coefficient values based on the lens defocus value, the motion value, and the rotation value. The imaging device may also determine a target position for the lens based on the lens position, the motion value, and the rotation value and the coefficient values. The imaging device may further adjust the lens based on the target position.

### BACKGROUND

### Field of the Disclosure

This disclosure relates generally to imaging devices and, more specifically, to autofocus convergence processes in imaging devices.

### Description of Related Art

Imaging devices, such as phones, tablets, and smart devices, may use various signal-processing techniques in an attempt to render high quality images. For example, the imaging devices may automatically focus their lens for image sharpness, automatically set the exposure time based on light levels, and automatically adjust the white balance to accommodate for the color temperature of a light source. Phase Detection Auto Focus (PDAF) is one example of autofocus and operates by comparing phase differences between certain pixels of left-view and right-view images, and computing a focus distance based on the phase differences. A position of a lens is then adjusted based on the computed focus distance. In some instances, however, these image signal-processing techniques may fail to perform as expected. For instance, in some examples, such as when capturing an image with objects in motion, or when the imaging devices is moving, autofocus techniques may cause blurring of the rendered images, among other image distortions.

### SUMMARY

According to one aspect, a method by an imaging device includes receiving lens autofocus data characterizing an adjustment of a lens of the imaging device. The method also includes receiving motion data characterizing a motion of an object within an image. Further, the method includes receiving rotation data characterizing a rotation (e.g., a jitter) of the imaging device. The method also includes determining a target position for the lens of the imaging device based on the lens autofocus data, the motion data, and the rotation data. The method further includes adjusting a position of the lens of the imaging device based on the target position.

According to another aspect, an apparatus comprises a non-transitory, machine-readable storage medium storing instructions, and at least one processor coupled to the non-transitory, machine-readable storage medium. The at least one processor is configured to execute the instructions to receive lens autofocus data characterizing an adjustment of a lens of the apparatus. The at least one processor is also configured to execute the instructions to receive motion data characterizing a motion of an object within an image. The at least one processor is further configured to execute the instructions to receive rotation data characterizing a rotation of the apparatus. The at least one processor is also configured to execute the instructions to determine a target position for the lens of the apparatus based on the lens autofocus data, the motion data, and the rotation data. Further, the at least one processor is also configured to execute the instructions to adjust a position of the lens of the apparatus based on the target position.

According to another aspect, a non-transitory, machine-readable storage medium storing instructions that, when executed by at least one processor, causes the at least one processor to perform operations that include receiving lens autofocus data characterizing an adjustment of a lens of the imaging device. The operations also include receiving motion data characterizing a motion of an object within an image. Further, the operations include receiving rotation data characterizing a rotation of the imaging device. The operations also include determining a target position for the lens of the imaging device based on the lens autofocus data, the motion data, and the rotation data. The operations further include adjusting a position of the lens of the imaging device based on the target position.

### BRIEF DESCRIPTION OF DRAWINGS

FIG. 1 is a block diagram of an exemplary imaging device, according to some implementations;

FIG. 2 is a diagram illustrating exemplary portions of the imaging device of FIG. 1, according to some implementations;

FIGS. 3A, 3B, and 3C illustrate graphs that map various input values to coefficient values according to some implementations;

FIGS. 4A and 4B illustrate diagrams of exemplary portions of the imaging device of FIG. 1, according to some implementations;

FIG. 5 is a flowchart of an exemplary process for determining a target position of a lens, according to some implementations; and FIG. 6 is a flowchart of another exemplary process for determining a target position of a lens, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

In some implementations, an imaging device may include one or more cameras, a gyroscope (GS) sensor, an automatic scene detection (ASD) engine, an autofocus (AF) engine such as a phase detection autofocus engine (PDAF), and a target position determination (TPD) engine. In some examples, each of the ASD engine, AF engine, and TBD engine may include instructions executed by one or more processors, such as one or more of camera processor 114, CPU 116, and GPU 118. Further, each camera may include, for example, one or more lenses and one or more imaging sensors. Each camera may also include one or more lens controllers that can adjust a position of the lenses. The imaging device may capture image data from each of the cameras. For example, the imaging device may capture first image data from a first camera, and may also capture second image data from a second camera. In some examples, the first camera and second camera may collectively establish a stereo camera (e.g., left and right cameras).

The ASD engine, when executed, may generate motion data characterizing motion of an object within an image captured by one or more of the cameras. For example, the executed ASD engine may perform object detection processes to identify an object within an image, and may track the object over subsequent images to determine the object's motion. The motion data may include, for instance, a motion value (e.g., motion vector) identifying a direction of motion of the object. In some examples, the motion data may identify a direction of motion in multiple dimensions. For example, the motion data may include a horizontal motion value characterizing a motion in a horizontal direction (e.g., “x” direction), and a vertical motion value characterizing a motion in a vertical direction (e.g., “y” direction).

The GS engine, when executed, may detect a rotation (e.g., jitter) of the imaging device, and may generate rotation data characterizing the detected rotation. For instance, the executed GS engine may detect a rotation of the imaging device due to, for example, inadvertent handshaking (e.g., jitter) when the imaging device is being held by a person, and may generate the rotation data characterizing the detected rotation. The rotation data may include a rotation value indicating the detected rotation (e.g., a number of degrees of rotation). For instance, the rotation data may include a rotation value indicating a current rotation position (e.g., in degrees). In some examples, the rotation data may include a rotation value indicating a rotational change from a current position (e.g., in degrees).

The AF engine, when executed, may generate lens autofocus data characterizing an adjustment of a lens of the imaging device. Adjusting the lens in accordance with the lens autofocus data may cause light from a region of interest (ROI) within a field of view (FOV) of the sensor to be focused in a plane of the sensor. The lens autofocus data may include, for instance, a lens defocus value characterizing a focus distance, and a lens position value indicating a lens position. In some examples, the lens position value indicates an amount to adjust the lens position by (e.g., an amount to adjust a current lens position by). In some examples, and as described herein, the AF engine may be a Phase Detection Auto Focus (PDAF) engine. The executed PDAF engine can compare phase differences between certain pixels of left-view and right-view images, and can compute a focus distance (e.g., lens defocus value) based on the phase differences. Further, and based on the focus distance, the executed PDAF engine can determine the lens position.

The executed TPD engine, when executed, may generate target position data characterizing a lens target position for the lens of the imaging device based on the motion data, the rotation data, and the lens autofocus data. For example, the executed TPD engine may extract the motion value from the motion data, the rotation value from the rotation data, and the lens position value and the lens defocus value from the lens autofocus data. Further, the executed TBD engine may determine a first coefficient based on the motion value, a second coefficient based on the rotation value, and a third coefficient based on the lens defocus value, and may determine the lens target position based on the lens position value, the first coefficient, the second coefficient, and the third coefficient.

In some examples, the executed TPD engine determines the first, second, and third coefficient values based on ranges of the motion, rotation, and lens position values, respectively. For instance, the executed TPD engine may determine the first coefficient is a first value when the motion value is within a first range, a second value when the motion value is within a second range, and a third value when the motion value is within a third range. Similarly, the executed TPD engine may determine the second coefficient is a first value when the rotation value is within a first range, a second value when the rotation value is within a second range, and a third value when the rotation value is within a third range. Further, the executed TPD engine may determine the third coefficient is a first value when the lens position value is within a first range, a second value when the lens position value is within a second range, and a third value when the lens position value is within a third range. Although described above with respect to three coefficient values for three corresponding ranges, the number of coefficient values and corresponding ranges can be greater than, or less than, three.

In some examples, a data repository stores a first look-up table that maps motion values to first coefficient values. Similarly, the data repository may store a second look-up table that maps rotation values to second coefficient values, and a third look-up table that maps lens defocus values to third coefficient values. The executed TPD engine may access the first look-up table to determine a first coefficient value that maps to the motion value. Similarly, the executed TPD engine may access the second look-up table to determine a second coefficient value that maps to the rotation value, and may access the third look-up table to determine a third coefficient value that maps to the lens defocus value. As described herein, the executed TPD engine may determine the lens target position based on the lens position value, the first coefficient value, the second coefficient value, and the third coefficient value. For instance, the executed TPD engine may multiply the lens position value with the first coefficient value, the second coefficient value, and the third coefficient value to determine the lens target position.

Further, a lens controller of the camera may adjust a position of the lens based on the lens target position generated by the executed TPD engine. Among other advantages, the imaging device may reduce AF (e.g., PDAF) converging speed during object or device movement and provide smoother lens movements, thereby reducing unwanted imaging effects, such as image blurring, in rendered images.

In some examples, the executed TPD engine may determine the lens target position using a different process, such as a time-of-flight (TOF) autofocus process or a contrast auto-focus (CAF) process. For instance, the executed TPD engine may determine whether the motion data indicates object motion beyond (e.g., greater than) a motion threshold. If the motion data (e.g., motion value) indicates an object motion beyond the motion threshold, the executed TPD engine may determine the lens target position based on a TOF autofocus process. The TOF autofocus process may generate, along with the lens target position, a confidence value. In some instances, the executed TPD engine may determine whether the confidence value is beyond (e.g., below) a confidence threshold. If the confidence value generated by the TOF autofocus process is beyond the confidence threshold, the executed TPD engine may ignore (e.g., discard) the lens target position generated by the TOF autofocus process, and instead determine the lens position based on the CAF process.

In some examples, the executed TPD engine determines whether the motion data indicates an object motion within a first range or a second range. If the motion is within the first range, the executed TPD engine determines the lens position value based on the TOF autofocus process described herein. If the motion is within the second range, the executed TPD engine determines the lens position value based on the CAF proves described herein.

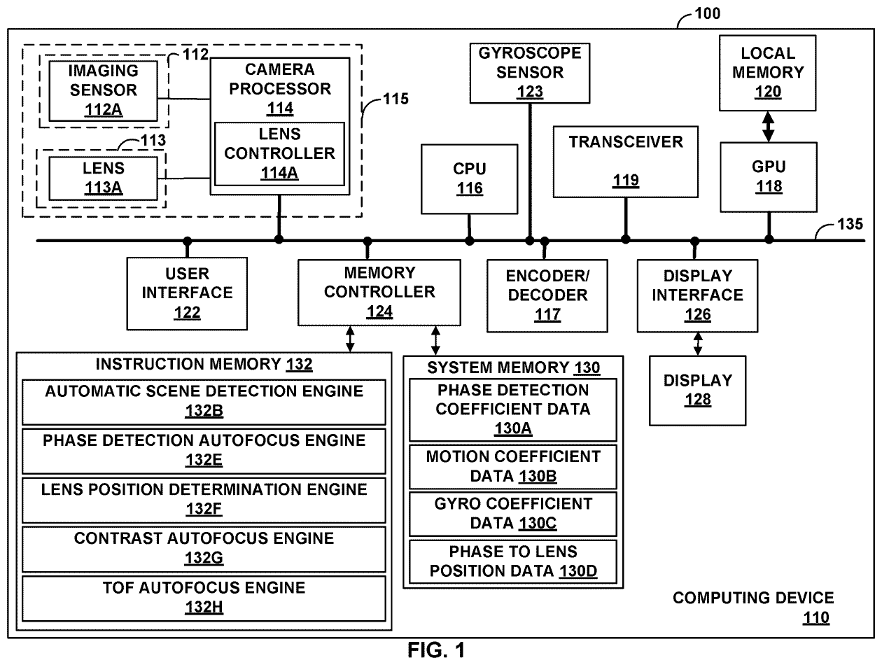

FIG. 1 is a block diagram of an exemplary imaging device 100. The functions of imaging device 100 may be implemented in one or more processors, one or more field-programmable gate arrays (FPGAs), one or more application-specific integrated circuits (ASICs), one or more state machines, digital circuitry, any other suitable circuitry, or any suitable hardware. Imaging device 100 may perform one or more of the exemplary functions and processes described in this disclosure. Examples of imaging device 100 include, but are not limited to, a camera, a video recording device such as a camcorder, a mobile device such as a tablet computer, a wireless communication device (such as, e.g., a mobile telephone, a cellular telephone, etc.), a handheld device, such as a portable video game device or a personal digital assistant (PDA), a virtual reality device (e.g., a virtual reality headset), an augmented reality device (e.g., augmented reality glasses), a virtual reality device (e.g., virtual reality headset), an extended reality device, or any device that may include one or more cameras.

As illustrated in the example of FIG. 1, imaging device 100 may include one or more imaging sensors 112, such as imaging sensor 112A, one or more lenses 113, such as lens 113A, and one or more camera processors, such as camera processor 114. Camera processor 114 may also include a lens controller 114A that is operable to adjust a position of one or more lenses 113, such as 113A. In some instances, the camera processor 114 may be an image signal processor (ISP) that employs various image processing algorithms to process image data (e.g., as captured by corresponding ones of these lenses and sensors). For example, the camera processor 114 may include an image front end (IFE) and/or an image processing engine (IPE) as part of a processing pipeline. Further, a camera 115 may refer to a collective device including one or more imaging sensors 112, one or more lenses 113, and one or more camera processors 114.

In some examples, one of or more of imaging sensors 112 may be allocated for each of lenses 113. Further, in some examples, one or more of imaging sensors 112 may be allocated to a corresponding one of lenses 113 of a respective, and different, lens type (e.g., a wide lens, ultra-wide lens, telephoto lens, and/or periscope lens, etc.). For instance, lenses 113 may include a wide lens, and a corresponding one of imaging sensors 112 having a first size (e.g., 108 MP) may be allocated to the wide lens. In other instance, lenses 113 may include an ultra-wide lens, and a corresponding one of imaging sensors 112 having a second, and different, size (e.g., 16 MP) may be allocated to the ultra-wide lens. In another instance, lenses 113 may include a telephoto lens, and a corresponding one of imaging sensors 112 having a third size (e.g., 12 MP) may be allocated to the telephoto lens.

In an illustrative example, a single imaging device 100 may include two or more cameras (e.g., two or more of camera 115), and at least two of the cameras include image sensors (e.g., imaging sensors 112) having a same size (e.g., two 12 MP sensors, three 108 MP sensors, three 12 MP sensors, two 12 MP sensors and a 108 MP sensor, etc.). Further, in some examples, a single image sensor, e.g., imaging sensor 112A, may be allocated to multiple ones of lenses 113. Additionally, or alternatively, each of imaging sensors 112 may be allocated to a different one of lenses 113, e.g., to provide multiple cameras to imaging device 100.

In some examples, imaging device 100 may include multiple cameras (e.g., a mobile phone having one or more front-facing cameras and one or more rear-facing cameras). For instance, imaging device 100 may include a first camera, such as camera 115 that includes a 16 MP image sensor, a second camera that includes a 108 MP image sensor, and a third camera that includes a 12 MP image sensor.

In some examples, imaging device 100 may include multiple cameras facing in different directions. For example, imaging device 100 may include dual “front-facing” cameras. Additionally, in some examples, imaging device 100 may include a “front-facing” camera, such as camera 115, and a “rear-facing” camera. In other examples, imaging device 100 may include dual “front-facing” cameras, which may include camera 115, and a “rear-facing” camera. In further examples, imaging device 100 may include three “front-facing” cameras, such as camera 115. In yet other examples, imaging device 100 may include three “front-facing” cameras, and one, two, or three “rear-facing” cameras. Further, a person of skill in the art would appreciate that the techniques of this disclosure may be implemented for any type of camera and for any number of cameras of imaging device 100.

Each of the imaging sensors 112, including imaging sensor 112A, may represent an image sensor that includes processing circuitry, an array of pixel sensors (e.g., pixels) for capturing representations of light, memory, an adjustable lens (such as lens 113), and an actuator to adjust the lens. By way of example, imaging sensor 112A may be associated with, and may capture images through, a corresponding one of lenses 113, such as lens 113A. In other examples, additional, or alternate, ones of imaging sensors 112 may be associated with, and capture images through, corresponding additional ones of lenses 113.

In some instances, imaging sensors 112 may include a monochrome sensor (e.g., a “clear” pixel sensor) and/or a color sensor (e.g., a Bayer sensor). For example, a monochrome pixel sensor may be established through a disposition of a monochrome filter over imaging sensor 112A. Further, in some examples, a color pixel sensor may be established through a disposition of a color filter, such as a Bayer filter, disposed over imaging sensor 112A, or through a disposition of a red filter, a green filter, or a blue filter may over imaging sensor 112A. Various other filter patterns exist, such as red, green, blue, white (“RGBW”) filter arrays; cyan, magenta, yellow, white (CMYW) filter arrays; and/or variations thereof, including proprietary or non-proprietary filter patterns.

Further, in some examples, multiple ones of lenses 113 may be associated with, and disposed over, respective subsets of imaging sensors 112. For instance, a first subset of imaging sensors 112 may be allocated to a first one of lenses 113 (e.g., a wide lens camera, ultra-wide lens camera, telephoto lens camera, periscope lens camera, etc.), and a second subset of imaging sensors 112 may be allocated to a second one of lenses 113 distinct from the first subset. In some instances, each of lenses 113 may serve respective functions as provided by various attributes of the cameras (e.g., lens attributes, aperture attributes, angle-of-view attributes, thermal imaging attributes, etc.), and a user of imaging device 100 may leverage the various attributes of each of lenses 113 to capture one or more images or sequences of images (e.g., as in a video recording).

Imaging device 100 may further include a central processing unit (CPU) 116, one or more gyroscope sensors 123, an encoder/decoder 117, a transceiver 119, a graphics processing unit (GPU) 118, a local memory 120 of GPU 118, a user interface 122, a memory controller 124 that provides access to system memory 130 and to instruction memory 132, and a display interface 126 that outputs signals that causes graphical data to be displayed on a display 128.

Each gyroscope sensor 123 (e.g., gyroscope) may be operable to measure a rotation of imaging device 100. In some examples, gyroscope sensors 123 may be distributed across the imaging device 100 to measure rotations of imaging device around one or more axis of imaging device 100 (e.g., yaw, pitch, and roll). Further, each gyroscope sensor 123 may generate gyro data characterizing a measured rotation, and may store the gyro data within a memory device (e.g., internal RAM, first-in-first out (FIFO), etc.). For instance, the gyro data may include one or more rotation values identifying a rotation of imaging device 100. CPU 116 and/or camera processor 114 may obtain (e.g., read) the generated gyro data from each gyro sensor

Additionally, in some instances, imaging device 100 may receive user input via user interface 122, and in response to the received user input, CPU 116 and/or camera processor 114 may activate respective ones of lenses 113, or combinations of lenses 113. For example, the received user input may corresponding a user selection of lens 113A (e.g., a fisheye lens), and based on the received user input, CPU 116 may select an initial one of lenses 113 to activate and additionally, or alternatively, may transition from the initially selected lens 113A to another one of lenses 113.

In other examples, CPU 116 and/or camera processor 114 may detect an operating condition that satisfies certain lens-selection criteria (e.g., digital zoom level satisfying a predefined camera transition threshold, a change in lighting conditions, input from a user calling for a particular lens 13, etc.), and may select the initial one of lenses 113, such as lens 113A, for activation based on the detected operating condition. For example, CPU 116 and/or camera processor 114 may generate and provide a lens adjustment command to lens controller 114A to adjust a position of a corresponding lens 113A. The lens adjustment command may identify a position to adjust the lens 113A to, or an amount by which to adjust a current lens position by, for example. In response, lens controller 114A may adjust the position of the lens 113A in accordance with the lens adjustment command. In some examples, imaging device 100 may include multiple ones of camera 115, which may collectively capture one synthetic image or stream of synthetic images, such that camera processor 114 or CPU 116 may process one synthetic image or stream of synthetic images based on image data captured from imaging sensors 112.

In some examples, each of lenses 113 and imaging sensors 112 may operate collectively to provide various optical zoom levels, angles of view (AOV), focal lengths, and FOVs. Further, light guides may be used to direct incident light from lenses 113 to a respective one of imaging sensors 112, and examples of the light guides may include, but are not limited to, a prism, a moving prism, or one or more mirrors. For instance, light received from lens 113A may be redirected from imaging sensor 112A toward another one of imaging sensors 112. Further, in some instances, camera processor 114 may perform operations that cause a prism to move and redirect light incident on lens 113A in order to effectively change the focal length for the received light.

Further, as illustrated in FIG. 1, a single camera processor, such as camera processor 114, may be allocated to and interface with all, or a selected subset, of imaging sensors 112. In other instances, multiple camera processors may be allocated to and interface with all, or a selected subset, of imaging sensors 112, and each of the camera processors may coordinate with one another to efficiently allocate processing resources to the all, or the selected subset, of imaging sensors 112. For example, and through the execution of stored instructions, camera processor 114 may implement multiple processing algorithms under various circumstances to perform digital zoom operations or other image processing operations.

Although the various components of imaging device 100 are illustrated as separate components, in some examples, the components may be combined to form a system on chip (SoC). As an example, camera processor 114, CPU 116, GPU 118, and display interface 126 may be implemented on a common integrated circuit (IC) chip. In some examples, one or more of camera processor 114, CPU 116, GPU 118, and display interface 126 may be implemented in separate IC chips. Various other permutations and combinations are possible, and the techniques of this disclosure should not be considered limited to the example of FIG. 1.

System memory 130 may store program modules and/or instructions and/or data that are accessible by camera processor 114, CPU 116, and GPU 118. For example, system memory 130 may store user applications (e.g., instructions for a camera application) and resulting images from camera processor 114. System memory 130 may also store data accessed by camera processor 114 to determine a position for a lens 113A as described herein. For example, system memory 130 may store one or more of phase detection coefficient data 130A, motion coefficient data 130B, and gyro coefficient data 130C. Phase detection coefficient data 130A may characterize a mapping of lens defocus values to coefficient values. For example, phase detection coefficient data 130A may identify a coefficient value for a range of lens defocus values. Similarly, motion coefficient data 130B may characterize a mapping of motion values to coefficient values, and gyro coefficient data 130C may characterize a mapping of rotation values to coefficient values. In some examples, one or more of phase detection coefficient data 130A, motion coefficient data 130B, and gyro coefficient data 130C may be stored as a lookup table in a data repository, such as system memory 130. As described herein, camera processor 114 may determine a target position for a lens 113A based on one or more of the stored coefficient values, and may cause lens controller 114A to adjust the position of the lens 113A based on the determined target position. System memory 130 may also store phase-to-lens position data 130D, which may characterize a mapping of phase differences (e.g., as generated by a phase detection autofocus process) to lens defocus values, as well as a mapping of lens defocus values to lens position values for one or more lenses, such as for the lens 113A.

System memory 130 may additionally store information for use by and/or generated by other components of imaging device 100. For example, system memory 130 may act as a device memory for camera processor 114. System memory 130 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

Similarly, GPU 118 may store data to, and read data from, local memory 120. For example, GPU 118 may store a working set of instructions to local memory 120, such as instructions loaded from instruction memory 132. GPU 118 may also use local memory 120 to store dynamic data created during the operation of imaging device 100. Examples of local memory 120 include one or more volatile or non-volatile memories or storage devices, such as RAM, SRAM, DRAM, EPROM, EEPROM, flash memory, a magnetic data media, a cloud-based storage medium, or an optical storage media.

Instruction memory 132 may store instructions that may be accessed (e.g., read) and executed by one or more of camera processor 114, CPU 116, and GPU 118. For example, instruction memory 132 may store instructions that, when executed by one or more of camera processor 114, CPU 116, and GPU 118, cause one or more of camera processor 114, CPU 116, and GPU 118 to perform one or more of the operations described herein. For instance, instruction memory 132 can include automatic scene detection (ASD) engine 132B that can include instructions that, when executed by one or more of camera processor 114, CPU 116, and GPU 118, cause one or more of camera processor 114, CPU 116, and GPU 118 to determine a motion for an object within a captured image, such as an object to be focused, and to generate motion data (e.g., a motion vector) characterizing the determined motion. Instruction memory 132 can also include phase detection autofocus (PDAF) engine 132E that can include instructions that, when executed by one or more of camera processor 114, CPU 116, and GPU 118, cause one or more of camera processor 114, CPU 116, and GPU 118 to determine phase differences between two captured images, such as left-view and right-view images, to determine a lens defocus value based on the phase differences (e.g., based on the mapping of phase differences to lens defocus values characterized within phase-to-lens position data 130D), and to determine a lens position value based on the determined lens defocus value (e.g., based on the mapping of lens defocus values to lens position values characterized within phase-to-lens position data 130D). Further, executed lens position determination engine 132F can include instructions that, when executed by one or more of camera processor 114, CPU 116, and GPU 118, cause one or more of camera processor 114, CPU 116, and GPU 118 to determine a target lens position for a lens 113, such as lens 113A, based on one or more of the gyro data, the autofocus lens position, and the motion data Instruction memory 132 may also include contrast autofocus engine 132G that can include instructions that, when executed by one or more of camera processor 114, CPU 116, and GPU 118, cause one or more of camera processor 114, CPU 116, and GPU 118 to apply a contrast autofocus process (e.g., contrast-detect autofocus process) to one or more images to generate the autofocus lens position. Instruction memory 132 may further include time-of-flight (TOF) autofocus engine 132H that can include instructions that, when executed by one or more of camera processor 114, CPU 116, and GPU 118, cause one or more of camera processor 114, CPU 116, and GPU 118 to perform a TOF autofocus process to determine depth, and to generate the autofocus lens position based on the determined depth. Instruction memory 132 may also store instructions that, when executed by one or more of camera processor 114, CPU 116, and GPU 118, cause one or more of camera processor 114, CPU 116, and GPU 118 to perform additional image processing operations, such as one or more of automatic gain (AG), automatic white balance (AWB), color correction, or zoom operations.

The various components of imaging device 100, as illustrated in FIG. 1, may be configured to communicate with each other across bus 135. Bus 135 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced extensible Interface (AXI) bus), or another type of bus or device interconnect. It is to be appreciated that the specific configuration of components and communication interfaces between the different components shown in FIG. 1 is merely exemplary, and other configurations of the components, and/or other image processing systems with the same or different components, may be configured to implement the operations and processes of this disclosure.

Memory controller 124 may be communicatively coupled to system memory 130 and to instruction memory 132. Memory controller 124 may facilitate the transfer of data going into and out of system memory 130 and/or instruction memory 132. For example, memory controller 124 may receive memory read and write commands, such as from camera processor 114, CPU 116, or GPU 118, and service such commands to provide memory services to system memory 130 and/or instruction memory 132. Although memory controller 124 is illustrated in the example of FIG. 1 as being separate from both CPU 116 and system memory 130, in other examples, some or all of the functionality of memory controller 124 may be implemented on one or both of CPU 116 and system memory 130. Likewise, some or all of the functionality of memory controller 124 may be implemented on one or both of CPU 116 and instruction memory 132.

Camera processor 114 may also be configured, by executed instructions, to analyze image pixel data and store resulting images (e.g., pixel values for each of the image pixels) to system memory 130 via memory controller 124. Each of the images may be further processed for generating a final image for display. For example, GPU 118 or some other processing unit, including camera processor 114 itself, may perform color correction, white balance, blending, compositing, rotation, digital zoom, or any other operations to generate the final image content for display.

CPU 116 may comprise a general-purpose or a special-purpose processor that controls operation of imaging device 100. A user may provide input to imaging device 100 to cause CPU 116 to execute one or more software applications. The software applications executed by CPU 116 may include, for example, a camera application, a graphics editing application, a media player application, a video game application, a graphical user interface application or another program. For example, and upon execution by CPU 116, a camera application may allow control of various settings of camera 115, e.g., via input provided to imaging device 100 via user interface 122. Examples of user interface 122 include, but are not limited to, a pressure-sensitive touchscreen unit, a keyboard, a mouse, or an audio input device, such as a microphone. For example, user interface 122 may receive input from the user to adjust desired zoom levels (e.g., digital zoom levels), alter aspect ratios of image data, record video, take a snapshot while recording video, apply filters when capturing images, select a region-of-interest (ROI) for AF (e.g., PDAF), AE, AG, or AWB operations, record slow motion video or super slow motion video, apply night shot settings, and/or capture panoramic image data, among other examples.

In some examples, one or more of CPU 116 and GPU 118 cause output data (e.g., a focused image of an object, a captured image, etc.) to be displayed on display 128. In some examples, the imaging device 100 transmits, via transceiver 119, the output data to another computing device, such as a server (e.g., cloud-based server) or a user's handheld device (e.g., cellphone). For example, the imaging device 100 may apply a PDAF process to captured left-view and right-view images of a scene to generate a final processed image, and may transmit the final processed image to another computing device.

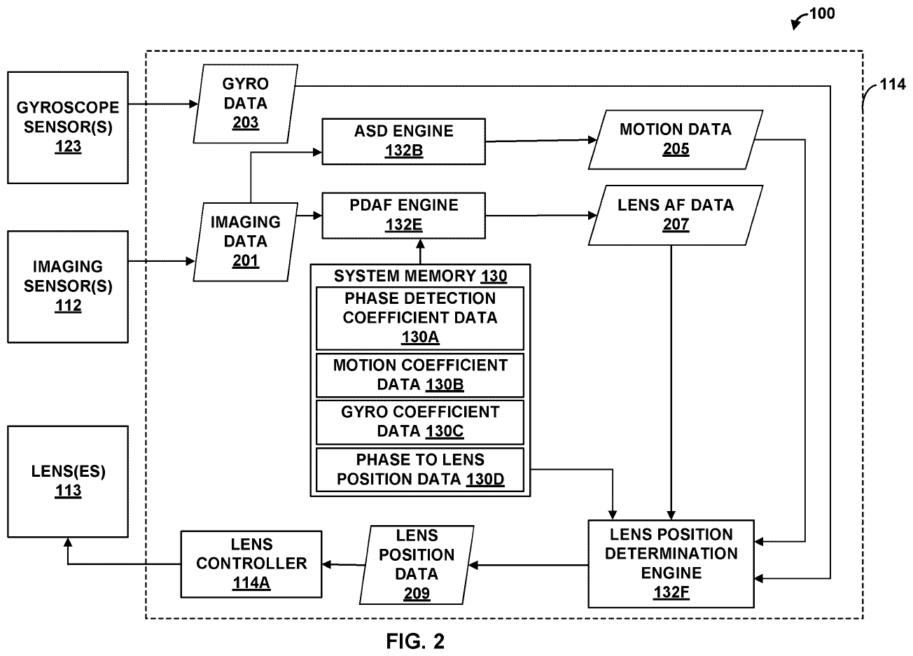

FIG. 2 is a diagram illustrating exemplary portions of the imaging device 100 of FIG. 1. In this example, imaging device 100 includes one or more gyroscope sensors 123, one or more imaging sensors 112, one or more lenses 113, lens controller 114A, and system memory 130. Further, imaging device 100 includes ASD engine 132B, PDAF engine 132E, and lens position determination engine 132F. As described herein, in some examples, each of ASD engine 132B, PDAF engine 132E, and lens position determination engine 132F may include instructions that, when executed by camera processor 114, cause camera processor 114 to perform corresponding operations. In some examples, one or more of ASD engine 132B, PDAF engine 132E, and lens position determination engine 132F may be implemented in hardware, such as within one or more FPGAs, ASICs, digital circuitry, or any other suitable hardware or hardware or hardware and software combination.

In this example, camera processor 114 captures imaging data 201 from the one or more imaging sensors 112 (e.g., based on light received through one or more lenses 113). The imaging data 201 may include, for instance, left-view and right view images of a scene. In some examples, camera processor 114 stores the imaging data 201 in a data repository, such as within system memory 130. Further, ASD engine 132B may receive the imaging data 201, and may apply an automatic scene detection process to the imaging data 201 to determine a motion of an object captured within the imaging data 201. For example, ASD engine 132B may apply object detection processes to an image characterized by the imaging data 201 to identify an object, and may track the object over multiple images to determine the object's motion. ASD engine 132B may generate motion data 205 characterizing the object's motion, and may provide motion data 205 to lens position determination engine 132F. Motion data 205 may include, for example, a motion value (e.g., motion vector) identifying and characterizing a motion direction of the object.

Additionally, PDAF engine 132E may receive imaging data 201, and may apply a phase detection autofocus process to the imaging data 201 to determine phase differences between two captured images, such as left-view and right-view images. Further, PDAF engine 132E may determine a lens defocus value (e.g., a depth of field value) for lens 113 based on the detected phase differences. For instance, PDAF engine 132E may access phase-to-lens position data 130D within system memory 130, which may include phase difference values mapped to lens defocus values, to obtain a lens defocus value that is mapped to (e.g., associated with) the determined phase differences. In some examples, PDAF engine 132E may perform operations that include the execution of an algorithm that operates on the phase differences to determine the lens defocus value. Further, PDAF engine 132E may perform operations to determine a lens position for the lens based on the lens defocus value. For example, and as described herein, phase-to-lens position data 130D may further include a mapping of lens defocus values to lens positions values. PDAF engine 132E may access the phase-to-lens position data 130D to obtain a lens position value that maps to the determined lens defocus value. Further, PDAF engine 132E may generate lens AF data 207 characterizing the determine lens defocus value and, in some examples, the determined lens position value, and may provide lens AF data 207 to lens position determination engine 132F. In some instances, PDAF engine 132E generates an AF confidence value characterizing a confidence level in the determined lens defocus value (e.g., 0=no confidence, 0.5=50% confidence, 1=full confidence). PDAF engine may include the AF confidence value within AF data 207.

In addition to receiving motion data 205 from ASD engine 132B and lens AF data 207 from PDAF engine 132E, lens position determination engine 132F may further obtain gyro data 203 from one or more gyroscope sensors 123. As described herein, gyro data 203 may characterize one or more rotations of imaging device 100 during capture of the imaging data 201. Based on motion data 205, lens AF data 207, and gyro data 203, lens position determination engine 132F may generate lens position data 209 characterizing an adjustment of the lens 113 (e.g., a lens adjustment command). Lens position data 209 may include, for example, a lens position to which to adjust the lens 113 to, or a value indicating a change to a current lens position of lens 113.

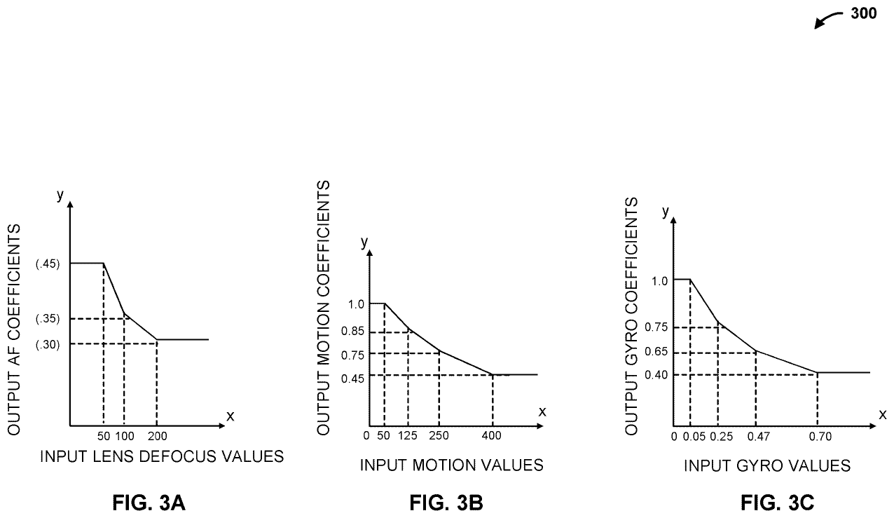

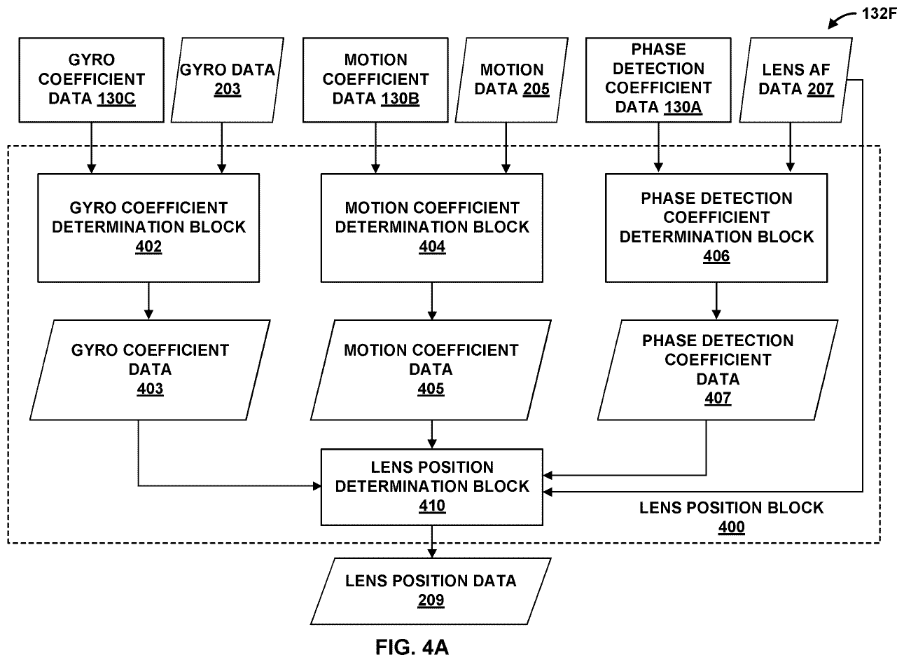

For instance, and as described herein, phase detection coefficient data 130A may characterize a mapping of lens defocus values to coefficient values. FIG. 3A, for example, illustrates a graph that maps lens defocus values to autofocus coefficient values. Specifically, the graph maps a range of lens defocus values to a coefficient value. For example, as illustrated, a lens defocus value of between 0 and 50, inclusively, is mapped to a coefficient value of 0.45, while a lens defocus value greater than 50 up to 100 is mapped to a coefficient value of 0.35, and a lens defocus value of greater than 100 up to 200 is mapped to a coefficient value of 0.30. Similarly, motion coefficient data 130B may characterize a mapping of motion values to coefficient values.

FIG. 3B illustrates a graph that maps a range of motion values to motion coefficient values. In this example, a motion value of between 0 and 50, inclusively, is mapped to a coefficient value of 1, while a motion value of greater than 50 up to 125 is mapped to a coefficient value of 0.85. Moreover, a motion value of greater than 125 up to 250 is mapped to a coefficient value of 0.75, and a motion value of greater than 250 up to 400 is mapped to a coefficient value of 0.45. Further, gyro coefficient data 130C may characterize a mapping of rotation values to coefficient values. Further, FIG. 3C illustrates a graph that maps gyro values to gyro coefficient values. In the example, a gyro value of in the range of 0 to 0.05, inclusively, is mapped to a coefficient value of 1, while an gyro value of greater than 0.05 up to 0.25 is mapped to a coefficient value of 0.75. Moreover, a gyro value greater than 0.25 up to 0.47 is mapped to a coefficient value of 0.65, and a gyro value of greater than 0.47 up to 0.70 is mapped to a coefficient value of 0.40. Each of the graphs of FIGS. 3A, 3B, and 3C may map one or more input values, or ranges of input values, to corresponding coefficient values. Coefficient values may fall within a range, such as, for example, within 0 to 1, inclusively.

In some examples, phase detection coefficient data 130A characterizes the graph of FIG. 3A. Further, in some examples, motion coefficient data 130B characterizes the graph of FIG. 3B, and gyro coefficient data 130C characterizes the graph of FIG. 3C. For instance, each of phase detection coefficient data 130A, motion coefficient data 130B, and gyro coefficient data 130C may include lookup tables characterizing the graphs of FIGS. 3A, 3B, and 3C, respectively.

Referring back to FIG. 2, lens position determination engine 132F may access phase detection coefficient data 130A, motion coefficient data 130B, and gyro coefficient data 130C within system memory 130 to obtain coefficient values based on lens AF data 207, motion data 205, and gyro data 203, respectively. For instance, lens position determination engine 132F may access phase detection coefficient data 130A to obtain (e.g., read) a first coefficient value that corresponds to a lens defocus value identified by the lens AF data 207. Lens position determination engine 132F may also access motion coefficient data 130B to obtain a second coefficient value that corresponds a motion value identified by motion data 205. Further, lens position determination engine 132F may access gyro coefficient data 130C to obtain a third coefficient value that corresponds to a rotation value identified by gyro data 203.

Moreover, lens position determination engine 132F may determine a target lens position for the lens 113 based on the obtained first coefficient value, second coefficient value, third coefficient value, and the lens position value identified within lens AF data 207. For example, lens position determination engine 132F may multiple the lens position value identified within lens AF data 207 with the first coefficient value, the second coefficient value, and the third coefficient value to determine the target lens position.

Based on the determined lens position, lens position determination engine 132F may generate lens position data 209 characterizing the target lens position of the lens 113. As described herein, the lens position data 209 may include the target lens position. In some examples, lens position determination engine 132F generates the lens position data 209 to include an amount by which to adjust a current lens position by. For instance, lens position determination engine 132F may determine the amount based on a current lens position of lens 113 and the target lens position. As an example, lens position determination engine 132F may subtract the target lens position by the current lens position to determine a value to adjust lens 113 by, and may include the determined value within lens position data 209. In some examples, lens position determination engine 132F updates the current lens position based on the determined amount to adjust, and stores the current lens position within system memory 130.

Lens position determination engine 132F may provide lens position data 209 to lens controller 114A to adjust a position of the lens 113. For example, lens controller 114A may receive lens position data 209, extract a value charactering the lens position from lens position data 209, and may adjust the position of the lens 113 in accordance with the extracted value. As such, the lens adjustment of lens 113 may be based on any detected rotations of the imaging device 100 (e.g., as identified within gyro data 203), any detected object motions (e.g., as identified within motion data 205), as well as an amount of defocus determined by AF processes (e.g., PDAF engine 132E).

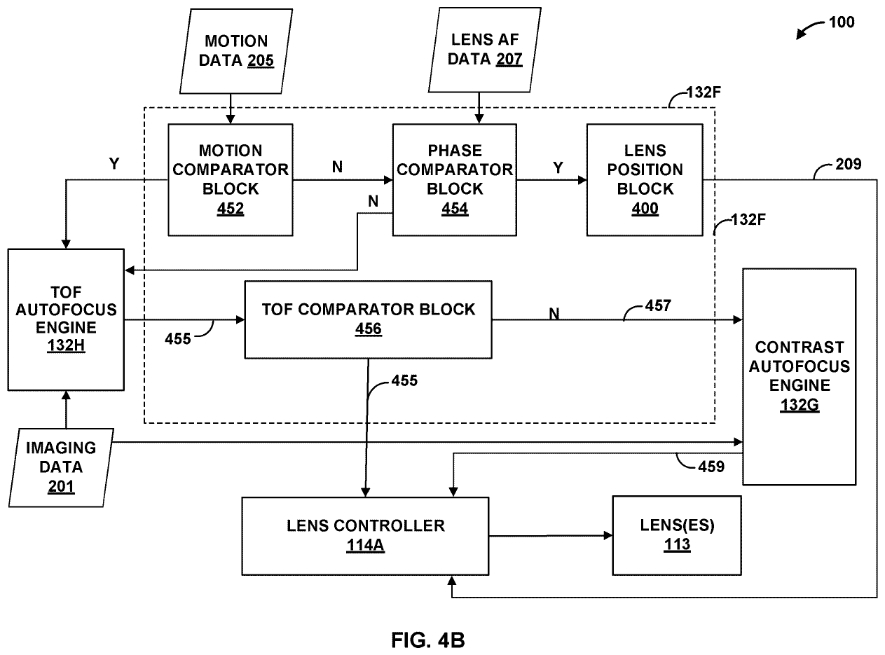

FIGS. 4A and 4B illustrate exemplary portions of imaging device 100. More specifically, FIG. 4A illustrates an exemplary embodiment of lens position determination engine 132F. In this example, lens position determination engine 132F includes lens position block 400, which includes a gyro coefficient determination block 402, a motion coefficient determination block 404, a phase detection coefficient determination block 406, and a lens position determination block 410. As described herein, lens position block 400, including gyro coefficient determination block 402, motion coefficient determination block 404, phase detection coefficient determination block 406, and lens position determination block 410, or portions thereof, may be implemented in instructions that, when executed by camera processor 114, cause camera processor 114 to perform corresponding operations. In some examples, lens position block 400, including one or more of gyro coefficient determination block 402, motion coefficient determination block 404, phase detection coefficient determination block 406, and lens position determination block 410, or portions thereof, may be implemented in hardware, such as within one or more FPGAs, ASICs, digital circuitry, or any other suitable hardware or hardware or hardware and software combination.

Gyro coefficient determination block 402 receives gyro data 203 from a gyroscope sensor 123, where the gyro data 203 characterizes a rotational value. Further, gyro coefficient determination block 402 may extract the rotational value from the gyro data 203, and may access gyro coefficient data 130C within system memory 130 to determine a coefficient based on the rotational value. For instance, and as described herein, gyro coefficient data 130C may characterize a mapping of rotation values to coefficient values. Gyro coefficient determination block 402 may perform operations to obtain gyro coefficient data 130C and determine the coefficient value mapping to the extracted rotational value. Further, gyro coefficient determination block 402 may generate gyro coefficient data 403 that includes the determined coefficient value, and may provide gyro coefficient data 403 to lens position determination block 410.

Motion coefficient determination block 404 receives motion data 205 from ASD engine 132B, where the motion data 205 includes a motion value characterizing a motion of an object captured within an image. Further, motion coefficient determination block 404 may extract the motion value from the motion data 205, and may access motion coefficient data 130B within system memory 130 to determine a coefficient based on the motion value. For instance, and as described herein, motion coefficient data 130B may characterize a mapping of motion values to coefficient values. Motion coefficient determination block 404 may perform operations to obtain motion coefficient data 130B and determine the coefficient value mapping to the extracted motion value. Further, motion coefficient determination block 404 may generate motion coefficient data 405 that includes the determined coefficient value, and may provide motion coefficient data 405 to lens position determination block 410.

Phase detection coefficient determination block 406 receives lens AF data 207 from PDAF engine 132E, where the lens AF data 207 includes a lens defocus value determined based on detected phase differences between images. Further, phase detection coefficient determination block 406 may extract the lens defocus value from the lens AF data 207, and may access phase detection coefficient data 130A within system memory 130 to determine a coefficient based on the lens defocus value. For instance, and as described herein, phase detection coefficient data 130A may characterize a mapping of lens defocus values to coefficient values. Phase detection coefficient determination block 406 may perform operations to obtain motion coefficient data 130B and determine the coefficient value mapping to the extracted lens defocus value. Further, phase detection coefficient determination block 406 may generate phase detection coefficient data 407 that includes the determined coefficient value, and may provide phase detection coefficient data 407 to lens position determination block 410.

Lens position determination block 410 may determine a target position for a lens, such as lens 113, based on gyro coefficient data 403, motion coefficient data 405, phase detection coefficient data 407, and the lens position value within lens AF data 207. For instance, lens position determination block 410 may extract the coefficient within each of the gyro coefficient data 403, the motion coefficient data 405, and the phase detection coefficient data 407, and may also extract the lens position value received within lens AF data 207. Further, lens position determination block 410 may determine the target lens position for lens 113 based on the coefficients and the lens position value. In some examples, lens position determination block 410 multiplies the coefficients with the lens position value to determine the target lens position value. Lens position determination block 410 may generate lens position data 209 characterizing the determined lens position, and may output lens position data 209.

Referring now to FIG. 4B, in some examples lens position determination engine 132F may include a motion comparator block 452, a phase comparator block 454, and a time-of-flight (TOF) comparator block 456. As described herein, each of motion comparator block 452, phase comparator block 454, and TOF comparator block 456, or portions thereof, may be implemented in instructions that, when executed by camera processor 114, cause camera processor 114 to perform corresponding operations. In some examples, motion comparator block 452, phase comparator block 454, and TOF comparator block 456, or portions thereof, may be implemented in hardware, such as within one or more FPGAS, ASICs, digital circuitry, or any other suitable hardware or hardware or hardware and software combination.

Referring back to FIG. 4B, motion comparator block 452 may perform operations to receive motion data 205, extract a motion value from motion data 205, and compare the extracted motion value with a first threshold. The first threshold may be stored and accessed from, for example, a data repository, such as system memory 130. If, for instance, motion comparator block 452 determines the motion value does not exceed the first threshold, the phase comparator block 454 performs operations that include extracting an AF confidence value from lens AF data 207. Further, phase comparator block 454 may compare the extracted AF confidence value with a second threshold. The second threshold may be stored and accessed from a data repository, such as system memory 130. If the confidence value exceeds the second threshold, the lens position block 400 generates lens position data 209 as described, for example, with respect to FIG. 4A.

If, however, the motion comparator block 452 determines that the motion value does exceed the first threshold, or the phase comparator block 454 determines that the AF confidence value does not exceed the second threshold, TOF autofocus engine 132H applies a TOF autofocus process to the captured images characterized by imaging data 201 to determine depth and a lens position based on the determined depth. TOF AF engine 132H may further generate a TOF confidence value characterizing a confidence level of the determined depth. Further, TOF AF engine 132H may generate TOF AF data 455 that includes one or more of the determined depth, the determined lens position, and the TOF confidence value.

TOF comparator block 456 may obtain TOF AF data 455 from TOF AF engine 132H, and may extract the TOF confidence value from TOF AF data 455. Further, TOF comparator block 456 may compare the TOF confidence value with a third threshold. The third threshold may be stored and accessed from a data repository, such as system memory 130. If, for instance, the TOF confidence value does not exceed the third threshold, contrast autofocus engine 132G may apply a contrast autofocus process to the captured images characterized by imaging data 201 to determine a lens position for lens 113. Contrast autofocus engine 132G may generate contrast AF data 459 charactering the lens position, and may provide the contrast AF data 459 to lens controller 114A. As described herein, lens controller 114A may perform operations to extract the lens position from contrast AF data 459, and to adjust a position of the lens 113 based on the extracted lens position. If, however, the TOF confidence value does exceed the third threshold, TOF comparator block may extract the lens position value from TOF AF data 455, and may generate TOF lens position data 453 that includes the extracted lens position. Further, TOF comparator block 456 may provide the TOF lens position data 453 to lens controller 114A. Lens controller 114A may perform operations to extract the lens position from TOF AF data 455, and to adjust a position of the lens 113 based on the extracted lens position.

As such, imaging device 100 may allow for lens control based on PDAF, TOF AF, and contrast AF processes based on detected object motion and confidence values. For example, the imaging device 100 may switch from PDAF to TOF or contrast based AF when significant motion, such as panning, is detected.

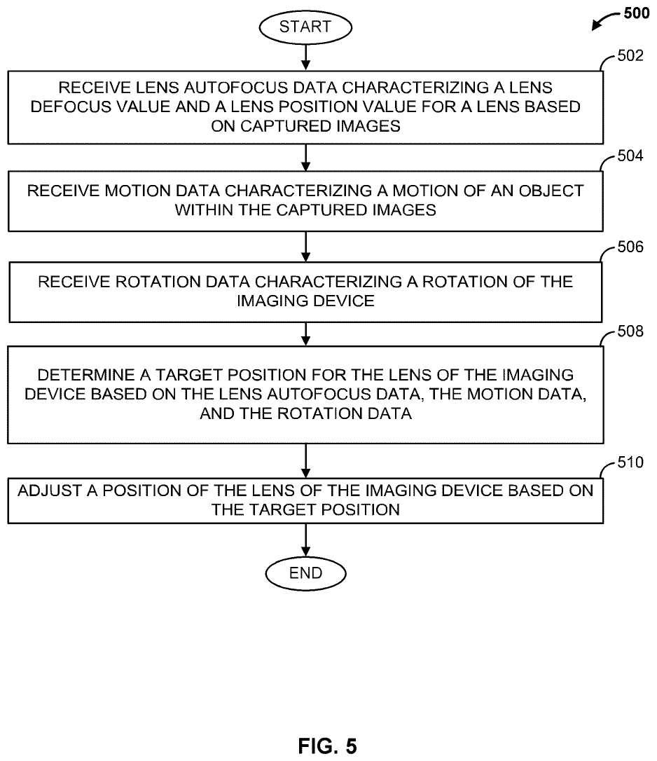

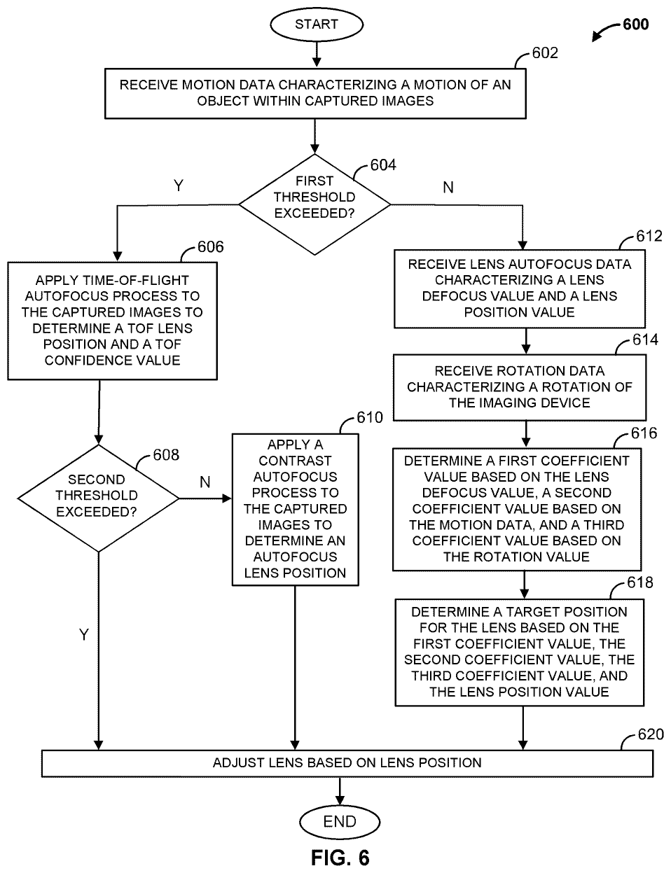

FIG. 5 is a flowchart of an exemplary process 500 for determining a target position of a lens. For example, one or more computing devices, such as imaging device 100, may perform one or more steps of exemplary process 500, as described below in reference to FIG. 5.

Referring to FIG. 5, imaging device 100 may perform, at step 502, any of the process described herein to receive lens autofocus data characterizing a lens defocus value and a lens position value for a lens based on captured images. For example, imaging device 100 may generate lens AF data 207, which may include a lens defocus value and a lens position value, based on applying one or more AF processes, such as PDAF process, to captured images. As described herein, the lens position value may be determined based on the lens defocus value and phase-to-lens position data 130D, which maps lens defocus values to lens position values. Further, the imaging device 100, at step 504, may receive motion data characterizing a motion of an object within the captured images. For example, the imaging device 100 may apply one or more automatic scene detection process to captured images to detect an object, and to determine a motion for the object, within the captured images. Further, and at step 506, the imaging device 100 may receive rotation data characterizing a rotation of the imaging device 100. For example, one or more gyroscope sensors 123 of imaging device 100 may generate gyro data 203 characterizing a rotation of imaging device 100 such as, for example, yaw, pitch, or roll.

At step 508, the imaging device 100 determines a target position for the lens based on the lens autofocus data, the motion data, and the rotation data. For instance, the imaging device 100 may extract a lens defocus value and a lens position value from the lens autofocus data, as well as a motion value from the motion data and a rotation value from the rotation data. Further, the imaging device 100 may determine a first coefficient value based on the lens defocus value, a second coefficient based on the motion value, and a third coefficient based on the rotation value. The first, second, and third coefficients may be determined based on phase detection coefficient data 130A, motion coefficient data 130B, and gyro coefficient data 130C, respectively, which map lens defocus values, motion values, and rotation values to coefficient values, respectively, as described herein. Imaging device 100 may determine the target position for the lens based on the first, second, and third coefficients, and the lens position value. For example, imaging device 100 may multiply the first, second, and third coefficients with the lens position value to determine the target position for the lens.

Proceeding to step 510, imaging device 100 adjusts a position of the lens based on the determined target position. For instance, lens controller 114A may receive lens position data 209 characterizing the determined target position, and may adjust lens 113 based on the determined target position.

FIG. 6 is a flowchart of an exemplary process 600 for determining a target position of a lens. For example, one or more computing devices, such as imaging device 100, may perform one or more steps of exemplary process 600, as described below in reference to FIG. 6.

Beginning at step 602, imaging device 100 may receive motion data characterizing a motion of an object within captured images. For example, the imaging device 100 may apply one or more automatic scene detection process to captured images to detect an object, and to determine a motion for the object, within the captured images. At step 604, the imaging device 100 determines whether the motion data characterizes a motion that exceeds a first threshold. If the motion exceed the first threshold, the method proceeds to step 606, where a time-of-flight autofocus process is applied to the captured images to determine a TOF lens position, and a TOF confidence value characterizing a confidence level in the TOF lens position.

Proceeding to step 608, the imaging device 100 determines whether the TOF confidence value exceeds a second threshold. If the TOF confidence value exceeds the second threshold, the method proceeds to step 620, where the lens is adjusted based on the TOF lens position. If, however, at step 608 the TOF confidence value does not exceed the second threshold, the method proceeds to step 610. At step 610, the imaging device 100 applies a contrast autofocus process to the captured images to determine an AF lens position, and the method proceeds to step 620, where the lens is adjusted based on the AF lens position.

Back at step 604, if the motion does not exceed the first threshold, the method proceeds to block 612, where imaging device 100 may perform of the processes described herein to receive lens autofocus data characterizing a lens defocus value and a lens position value for a lens based on the captured images. For example, imaging device 100 may generate lens AF data 207, which may include a lens defocus value and a lens position value, based on applying one or more AF processes, such as PDAF processes, to captured images. As described herein, the lens position value may be determined based on the lens defocus value and phase-to-lens position data 130D, which maps lens defocus values to lens position values. Further, and at step 614, the imaging device 100 may receive rotation data characterizing a rotation of the imaging device 100. For example, one or more gyroscope sensors 123 of imaging device 100 may generate gyro data 203 characterizing a rotation of imaging device 100 such as, for example, yaw, pitch, or roll.

Proceeding to step 616, the imaging device 100 determines a first coefficient value based on the lens defocus value, a second coefficient value based on the motion data, and a third coefficient value based on the rotation data. For instance, the imaging device 100 may extract a lens defocus value and a lens position value from the lens autofocus data, as well as a motion value from the motion data and a rotation value from the rotation data. Further, the imaging device 100 may access phase detection coefficient data 130A within system memory 130 to determine the first coefficient value, which is a coefficient value that is mapped to the lens position value. Similarly, the imaging device 100 may access motion coefficient data 130B within system memory 130 to determine the second coefficient value, which is a coefficient value mapped to the motion value. The imaging device 100 may also access gyro coefficient data 130C within system memory 130 to determine the third coefficient value, which is a coefficient value mapped to the rotation value.

At step 618, the imaging device 100 determines the target position for the lens based on the first, second, and third coefficients, and the lens position value. For example, imaging device 100 may multiply the first, second, and third coefficients with the lens position value to determine the target position for the lens.

Implementation examples are further described in the following numbered clauses:
1. An apparatus comprising:
a non-transitory, machine-readable storage medium storing instructions; and
at least one processor coupled to the non-transitory, machine-readable storage medium, the at least one processor being configured to execute the instructions to:
   receive lens autofocus data characterizing an adjustment of a lens of the apparatus;
   receive motion data characterizing a motion of an object within an image;
   receive rotation data characterizing a rotation of the apparatus;
   determine a target position for the lens of the apparatus based on the lens autofocus data, the motion data, and the rotation data; and
   adjust the lens of the imaging device based on the target position.
2. The apparatus of clause 1, wherein the lens autofocus data comprises a lens defocus value and a lens position value, the motion data comprises a motion value, and the rotation data comprises a rotation value, and wherein the at least one processor is further configured to execute the instructions to:
determine a first coefficient value based on the lens defocus value;
determine a second coefficient value based on the motion value;
determine a third coefficient value based on the rotation value; and
determine the target position for the lens of the apparatus based on the first coefficient value, the second coefficient value, the third coefficient value, and the lens position value.
3. The apparatus of clause 2, wherein the at least one processor is configured to execute the instruction to:
determine the target position based on a product of the lens position value, the first coefficient value, the second coefficient value, and the third coefficient value.
4. The apparatus of any of clauses 2-3, wherein the at least one processor is configured to execute the instruction to:
determine the first coefficient value based on a mapping of a plurality of lens defocus values to a plurality of first coefficient values, the plurality of first coefficient values comprising the first coefficient value.
5. The apparatus of any of clauses 2-4, wherein the at least one processor is configured to execute the instruction to:
determine the second coefficient value based on a mapping of a plurality of motion values to a plurality of second coefficient values, the plurality of second coefficient values comprising the second coefficient value.
6. The apparatus of any of clauses 2-5, wherein the at least one processor is configured to execute the instruction to:
determine the third coefficient value based on a mapping of a plurality of rotation values to a plurality of third coefficient values, the plurality of third coefficient values comprising the third coefficient value.
7. The apparatus of any of clauses 1-6, wherein the motion data comprises a motion value, and wherein the at least one processor is configured to execute the instruction to:
compare the motion value to a first threshold; and
based on the comparison, determine the target position for the lens of the apparatus based on the lens autofocus data, the motion data, and the rotation data.
8. The apparatus of clause 7, wherein the lens autofocus data comprises a confidence value, and wherein the at least one processor is configured to execute the instruction to:
compare the confidence value to a second threshold; and based on the comparison, determine the target position for the lens of the apparatus based on the lens autofocus data, the motion data, and the rotation data.
9. The apparatus of any of clauses 7-8, wherein the at least one processor is configured to execute the instruction to:
receive additional motion data characterizing a motion of an object within an additional image, the additional motion data comprising a second motion value;
compare the second motion value to the first threshold;
based on the comparison, apply a time-of-flight autofocus process to the additional image to determine a time-of-flight lens position; and
adjust the lens of the imaging device based on the time-of-flight lens position.
10. The apparatus of any of clauses 7-8, wherein the at least one processor is configured to execute the instruction to:
receive additional motion data characterizing a motion of an object within an additional image, the additional motion data comprising a second motion value;
compare the second motion value to the first threshold;
based on the comparison, apply a time-of-flight autofocus process to the additional image to determine a time-of-flight confidence value;
compare the time-of-flight confidence value to a second threshold;
based on the comparison, apply a contrast autofocus process to the additional image to determine a contrast lens position; and
adjust the lens of the imaging device based on the contrast lens position.
11. A method for adjusting a lens of an imaging device, the method comprising:
receiving lens autofocus data characterizing an adjustment of a lens of the apparatus determined from applying an autofocus process to an image;
receiving motion data characterizing a motion of an object within the image;
receiving rotation data characterizing a rotation of the apparatus;
determining a target position for the lens of the apparatus based on the lens autofocus data, the motion data, and the rotation data; and
adjusting the lens of the imaging device based on the target position.
12. The method of clause 11, wherein the lens autofocus data comprises a lens defocus value and a lens position value, the motion data comprises a motion value, and the rotation data comprises a rotation value, the method comprising:
determining a first coefficient value based on the lens defocus value;
determining a second coefficient value based on the motion value;
determining a third coefficient value based on the rotation value; and
determining the target position for the lens of the apparatus based on the first coefficient value, the second coefficient value, the third coefficient value, and the lens position value.
13. The method of clause 12, comprising determining the target position based on a product of the lens position value, the first coefficient value, the second coefficient value, and the third coefficient value.
14. The method of any of clauses 12-13, comprising determining the first coefficient value based on a mapping of a plurality of lens defocus values to a plurality of first coefficient values, the plurality of first coefficient values comprising the first coefficient value.
15. The method of any of clauses 12-14, comprising determining the second coefficient value based on a mapping of a plurality of motion values to a plurality of second coefficient values, the plurality of second coefficient values comprising the second coefficient value.
16. The method of any of clauses 12-15, comprising determining the third coefficient value based on a mapping of a plurality of rotation values to a plurality of third coefficient values, the plurality of third coefficient values comprising the third coefficient value.
17. The method of any of clauses 11-16, comprising:
comparing the motion value to a first threshold; and
based on the comparison, determining the target position for the lens of the apparatus based on the lens autofocus data, the motion data, and the rotation data.
18. The method of clause 17, wherein the lens autofocus data comprises a confidence value, the method comprising:
comparing the confidence value to a second threshold; and
based on the comparison, determining the target position for the lens of the apparatus based on the lens autofocus data, the motion data, and the rotation data.
19. The method of any of clauses 17-18, comprising:
receiving additional motion data characterizing a motion of an object within an additional image, the additional motion data comprising a second motion value;
comparing the second motion value to the first threshold;
based on the comparison, applying a time-of-flight autofocus process to the additional image to determine a time-of-flight lens position; and
adjusting the lens of the imaging device based on the time-of-flight lens position.
20. The method of any of clauses 17-18, comprising:
receiving additional motion data characterizing a motion of an object within an additional image, the additional motion data comprising a second motion value;
comparing the second motion value to the first threshold;
based on the comparison, apply a time-of-flight autofocus process to the additional image to determine a time-of-flight confidence value;
comparing the time-of-flight confidence value to a second threshold;
based on the comparison, apply a contrast autofocus process to the additional image to determine a contrast lens position; and
adjusting the lens of the imaging device based on the contrast lens position.
21. A non-transitory, machine-readable storage medium storing instructions that, when executed by at least one processor, causes the at least one processor to perform operations that include:
receiving lens autofocus data characterizing an adjustment of a lens of the apparatus determined from applying an autofocus process to an image;
receiving motion data characterizing a motion of an object within the image;
receiving rotation data characterizing a rotation of the apparatus;
determining a target position for the lens of the apparatus based on the lens autofocus data, the motion data, and the rotation data; and
adjusting the lens of the imaging device based on the target position.
22. The non-transitory, machine-readable storage medium of clause 21, wherein the lens autofocus data comprises a lens defocus value and a lens position value, the motion data comprises a motion value, and the rotation data comprises a rotation value, the operations comprising:
determining a first coefficient value based on the lens defocus value;
determining a second coefficient value based on the motion value;
determining a third coefficient value based on the rotation value; and
determining the target position for the lens of the apparatus based on the first coefficient value, the second coefficient value, the third coefficient value, and the lens position value.
23. The non-transitory, machine-readable storage medium of clause 22, the operations comprising determining the target position based on a product of the lens position value, the first coefficient value, the second coefficient value, and the third coefficient value.
24. The non-transitory, machine-readable storage medium of any of clauses 22-23, the operations comprising determining the first coefficient value based on a mapping of a plurality of lens defocus values to a plurality of first coefficient values, the plurality of first coefficient values comprising the first coefficient value.
25. The non-transitory, machine-readable storage medium of any of clauses 22-24, the operations comprising determining the second coefficient value based on a mapping of a plurality of motion values to a plurality of second coefficient values, the plurality of second coefficient values comprising the second coefficient value.
26. The non-transitory, machine-readable storage medium of any of clauses 22-25, the operations comprising determining the third coefficient value based on a mapping of a plurality of rotation values to a plurality of third coefficient values, the plurality of third coefficient values comprising the third coefficient value.
27. The non-transitory, machine-readable storage medium of any of clauses 21-26, the operations comprising:
comparing the motion value to a first threshold; and
based on the comparison, determining the target position for the lens of the apparatus based on the lens autofocus data, the motion data, and the rotation data.
28. The non-transitory, machine-readable storage medium of clause 27, wherein the lens autofocus data comprises a confidence value, the operations comprising:
comparing the confidence value to a second threshold; and
based on the comparison, determining the target position for the lens of the apparatus based on the lens autofocus data, the motion data, and the rotation data.
29. The non-transitory, machine-readable storage medium of any of clauses 27-28, the operations comprising:
receiving additional motion data characterizing a motion of an object within an additional image, the additional motion data comprising a second motion value;
comparing the second motion value to the first threshold;
based on the comparison, applying a time-of-flight autofocus process to the additional image to determine a time-of-flight lens position; and
adjusting the lens of the imaging device based on the time-of-flight lens position.
30. The non-transitory, machine-readable storage medium of any of clauses 27-28, the operations comprising:
receiving additional motion data characterizing a motion of an object within an additional image, the additional motion data comprising a second motion value;
comparing the second motion value to the first threshold;
based on the comparison, apply a time-of-flight autofocus process to the additional image to determine a time-of-flight confidence value;
comparing the time-of-flight confidence value to a second threshold;
based on the comparison, apply a contrast autofocus process to the additional image to determine a contrast lens position; and
adjusting the lens of the imaging device based on the contrast lens position.
31. An apparatus comprising:
a means for receiving lens autofocus data characterizing an adjustment of a lens of the apparatus;
a means for receiving motion data characterizing a motion of an object within an image;
a means for receiving rotation data characterizing a rotation of the apparatus;
a means for determining a target position for the lens of the apparatus based on the lens autofocus data, the motion data, and the rotation data; and
a means for adjusting the lens of the imaging device based on the target position.
32. The apparatus of clause 31, wherein the lens autofocus data comprises a lens defocus value and a lens position value, the motion data comprises a motion value, and the rotation data comprises a rotation value, comprising:
a means for determining a first coefficient value based on the lens defocus value;
a means for determining a second coefficient value based on the motion value;
a means for determining a third coefficient value based on the rotation value; and
a means for determining the target position for the lens of the apparatus based on the first coefficient value, the second coefficient value, the third coefficient value, and the lens position value.
33. The apparatus of clause 32, comprising:
a means for determining the target position based on a product of the lens position value, the first coefficient value, the second coefficient value, and the third coefficient value.
34. The apparatus of any of clauses 32-33, comprising:
a means for determining the first coefficient value based on a mapping of a plurality of lens defocus values to a plurality of first coefficient values, the plurality of first coefficient values comprising the first coefficient value.
35. The apparatus of any of clauses 3-34, comprising:
a means for determining the second coefficient value based on a mapping of a plurality of motion values to a plurality of second coefficient values, the plurality of second coefficient values comprising the second coefficient value.

36. The apparatus of any of clauses 32-35, comprising:
a means for determining the third coefficient value based on a mapping of a plurality of rotation values to a plurality of third coefficient values, the plurality of third coefficient values comprising the third coefficient value.

37. The apparatus of any of clauses 31-36, wherein the motion data comprises a motion value, comprising:
a means for comparing the motion value to a first threshold; and
a means for, based on the comparison, determining the target position for the lens of the apparatus based on the lens autofocus data, the motion data, and the rotation data.
38. The apparatus of clause 37, wherein the lens autofocus data comprises a confidence value, comprising:
a means for comparing the confidence value to a second threshold; and
a means for, based on the comparison, determining the target position for the lens of the apparatus based on the lens autofocus data, the motion data, and the rotation data.
39. The apparatus of any of clauses 37-38, comprising:
a means for receiving additional motion data characterizing a motion of an object within an additional image, the additional motion data comprising a second motion value;
a means for comparing the second motion value to the first threshold;
a means for, based on the comparison, applying a time-of-flight autofocus process to the additional image to determine a time-of-flight lens position; and
a means for adjusting the lens of the imaging device based on the time-of-flight lens position.
40. The apparatus of any of clauses 37-38, comprising:
a means for receiving additional motion data characterizing a motion of an object within an additional image, the additional motion data comprising a second motion value;
a means for comparing the second motion value to the first threshold;
a means for, based on the comparison, applying a time-of-flight autofocus process to the additional image to determine a time-of-flight confidence value;
a means for comparing the time-of-flight confidence value to a second threshold;
a means for, based on the comparison, applying a contrast autofocus process to the additional image to determine a contrast lens position; and
a means for adjusting the lens of the imaging device based on the contrast lens position.

Although the methods described above are with reference to the illustrated flowcharts, many other ways of performing the acts associated with the methods may be used. For example, the order of some operations may be changed, and some embodiments may omit one or more of the operations described and/or include additional operations.

In addition, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

The subject matter has been described in terms of exemplary embodiments. Because they are only examples, the claimed inventions are not limited to these embodiments. Changes and modifications may be made without departing the spirit of the claimed subject matter. It is intended that the claims cover such changes and modifications.

We claim:

1. An apparatus comprising:
a non-transitory, machine-readable storage medium storing instructions; and
at least one processor coupled to the non-transitory, machine-readable storage medium, the at least one processor being configured to execute the instructions to:
receive lens autofocus data characterizing an adjustment of a lens of the apparatus determined from applying an autofocus process to an image;
receive motion data characterizing a motion of an object within the image;
receive rotation data characterizing a rotation of the apparatus;
determine a target position for the lens of the apparatus based on the lens autofocus data, the motion data, and the rotation data; and
adjust the lens of the imaging device based on the target position.

2. The apparatus of claim 1, wherein the lens autofocus data comprises a lens defocus value and a lens position value, the motion data comprises a motion value, and the rotation data comprises a rotation value, and wherein the at least one processor is further configured to execute the instructions to:
determine a first coefficient value based on the lens defocus value;
determine a second coefficient value based on the motion value;
determine a third coefficient value based on the rotation value; and
determine the target position for the lens of the apparatus based on the first coefficient value, the second coefficient value, the third coefficient value, and the lens position value.

3. The apparatus of claim 2, wherein the at least one processor is configured to execute the instruction to:
determine the target position based on a product of the lens position value, the first coefficient value, the second coefficient value, and the third coefficient value.

4. The apparatus of claim 2, wherein the at least one processor is configured to execute the instruction to:
determine the first coefficient value based on a mapping of a plurality of lens defocus values to a plurality of first coefficient values, the plurality of first coefficient values comprising the first coefficient value.

5. The apparatus of claim 2, wherein the at least one processor is configured to execute the instruction to:
determine the second coefficient value based on a mapping of a plurality of motion values to a plurality of second coefficient values, the plurality of second coefficient values comprising the second coefficient value.

6. The apparatus of claim 2, wherein the at least one processor is configured to execute the instruction to:
determine the third coefficient value based on a mapping of a plurality of rotation values to a plurality of third coefficient values, the plurality of third coefficient values comprising the third coefficient value.

7. The apparatus of claim 1, wherein the motion data comprises a motion value, and wherein the at least one processor is configured to execute the instruction to:
compare the motion value to a first threshold; and
based on the comparison, determine the target position for the lens of the apparatus based on the lens autofocus data, the motion data, and the rotation data.

8. The apparatus of claim 7, wherein the lens autofocus data comprises a confidence value, and wherein the at least one processor is configured to execute the instruction to:
compare the confidence value to a second threshold; and
based on the comparison, determine the target position for the lens of the apparatus based on the lens autofocus data, the motion data, and the rotation data.

9. The apparatus of claim 7, wherein the at least one processor is configured to execute the instruction to:
receive additional motion data characterizing a motion of an object within an additional image, the additional motion data comprising a second motion value;
compare the second motion value to the first threshold;
based on the comparison, apply a time-of-flight autofocus process to the additional image to determine a time-of-flight lens position; and
adjust the lens of the imaging device based on the time-of-flight lens position.

10. The apparatus of claim 7, wherein the at least one processor is configured to execute the instruction to:
receive additional motion data characterizing a motion of an object within an additional image, the additional motion data comprising a second motion value;
compare the second motion value to the first threshold;
based on the comparison, apply a time-of-flight autofocus process to the additional image to determine a time-of-flight lens position and a time-of-flight confidence value;
compare the time-of-flight confidence value to a second threshold;
based on the comparison, apply a contrast autofocus process to the additional image to determine a contrast lens position; and
adjust the lens of the imaging device based on the contrast lens position.

11. A method for adjusting a lens of an imaging device, the method comprising:
receiving lens autofocus data characterizing an adjustment of a lens of the apparatus determined from applying an autofocus process to an image;
receiving motion data characterizing a motion of an object within the image;
receiving rotation data characterizing a rotation of the apparatus;
determining a target position for the lens of the apparatus based on the lens autofocus data, the motion data, and the rotation data; and
adjusting the lens of the imaging device based on the target position.

12. The method of claim 11, wherein the lens autofocus data comprises a lens defocus value and a lens position value, the motion data comprises a motion value, and the rotation data comprises a rotation value, the method comprising:
determining a first coefficient value based on the lens defocus value;
determining a second coefficient value based on the motion value;
determining a third coefficient value based on the rotation value; and
determining the target position for the lens of the apparatus based on the first coefficient value, the second coefficient value, the third coefficient value, and the lens position value.

13. The method of claim 12, comprising determining the target position based on a product of the lens position value, the first coefficient value, the second coefficient value, and the third coefficient value.

14. The method of claim 12, comprising determining the first coefficient value based on a mapping of a plurality of lens defocus values to a plurality of first coefficient values, the plurality of first coefficient values comprising the first coefficient value.

15. The method of claim 12, comprising determining the second coefficient value based on a mapping of a plurality of motion values to a plurality of second coefficient values, the plurality of second coefficient values comprising the second coefficient value.

16. The method of claim 12, comprising determining the third coefficient value based on a mapping of a plurality of rotation values to a plurality of third coefficient values, the plurality of third coefficient values comprising the third coefficient value.

17. The method of claim 11, comprising:
comparing the motion value to a first threshold; and
based on the comparison, determining the target position for the lens of the apparatus based on the lens autofocus data, the motion data, and the rotation data.

18. The method of claim 17, wherein the lens autofocus data comprises a confidence value, the method comprising:
comparing the confidence value to a second threshold; and
based on the comparison, determining the target position for the lens of the apparatus based on the lens autofocus data, the motion data, and the rotation data.

19. The method of claim 17, comprising:
receiving additional motion data characterizing a motion of an object within an additional image, the additional motion data comprising a second motion value;
comparing the second motion value to the first threshold;
based on the comparison, applying a time-of-flight autofocus process to the additional image to determine a time-of-flight lens position; and
adjusting the lens of the imaging device based on the time-of-flight lens position.

20. A non-transitory, machine-readable storage medium storing instructions that, when executed by at least one processor, causes the at least one processor to perform operations that include:
receiving lens autofocus data characterizing an adjustment of a lens of the apparatus determined from applying an autofocus process to an image;
receiving motion data characterizing a motion of an object within the image;
receiving rotation data characterizing a rotation of the apparatus;
determining a target position for the lens of the apparatus based on the lens autofocus data, the motion data, and the rotation data; and
adjusting the lens of the imaging device based on the target position.
